(19) United States
(12) Patent Application Publication
(10) Pub. No.: US 2022/0001621 A1
(43) Pub. Date: Jan. 6, 2022

(54) METHOD AND CLEANING SYSTEM FOR CLEANING THREE-DIMENSIONAL OBJECTS

(71) Applicant: Rapid Shape GmbH, Heimsheim (DE)

(72) Inventors: Andreas Schultheiss, Muehlacker (DE); Andreas Geitner, Leonberg (DE)

(21) Appl. No.: 17/444,931

(22) Filed: Aug. 12, 2021

Related U.S. Application Data
(63) Continuation of application No. PCT/EP2020/053944, filed on Feb. 14, 2020.

(30) Foreign Application Priority Data
Feb. 14, 2019 (DE) DE 10 2019 103 81

(51) Int. Cl. B29C 64/35; B33Y 40/00

(52) U.S. Cl. CPC B29C 64/35; B08B 3/104; B33Y 40/00

(57) ABSTRACT

The invention relates to a cleaning system for cleaning at least one three-dimensional object which is formed by solidification, in particular layer by layer or continuously, of a material which is solidifiable under the action of radiation, which cleaning system comprises a cleaning chamber for receiving the at least one three-dimensional object to be cleaned, wherein the cleaning system comprises at least one cleaning agent container containing uncontaminated cleaning agent, wherein the cleaning chamber and the at least one cleaning agent container are fluidically connected to one another, wherein the cleaning system comprises at least one conveying device for conveying uncontaminated cleaning agent from the at least one cleaning agent container into the cleaning chamber and for conveying contaminated cleaning agent from the cleaning chamber back into the at least one cleaning agent container. A method for cleaning at least one three-dimensional object is also proposed.

### CROSS-REFERENCE TO RELATED APPLICATIONS

This application is a continuation of international application number PCT/EP2020/053944 filed on Feb. 14, 2020 and claims the benefit of German application number 10 2019 103 816.2 filed on Feb. 14, 2019, which are incorporated herein by reference in their entirety and for all purposes.

### FIELD OF THE INVENTION

The present invention relates to cleaning systems for cleaning at least one three-dimensional object generally, and more specifically to a cleaning system for cleaning at least one three-dimensional object which is formed by solidification, in particular layer by layer or continuously, of a material which is solidifiable under the action of radiation.

### BACKGROUND OF THE INVENTION

The present invention also relates to methods for cleaning at least one three-dimensional object generally, and more specifically to a method for cleaning at least one three-dimensional object which is formed by solidification, in particular layer by layer or continuously, of a material which is solidifiable under the action of radiation.

Apparatuses for producing three-dimensional objects by solidification of a material which is solidifiable under the action of radiation are becoming increasingly important. They are known in particular as so-called 3D printers, by means of which objects can be produced individually, quickly and with a high degree of precision. Such apparatuses are used in particular in the field of dentistry. Exemplary embodiments of such apparatuses are described for example in DE 10 2013 107 571 A1.

A problem with the production of three-dimensional objects of the described kind lies in particular in the fact that, once completed, i.e. after curing, when removing these objects from the apparatus, i.e. the 3D printer, they are still contaminated with the solidifiable material. This material is constituted in particular by liquid plastics materials, in particular resins or polymer solutions, which have to be disposed of in part as hazardous waste if they are not cured.

It goes without saying that, when removing produced three-dimensional objects from a 3D printer of this kind, contamination of the operating individual is practically unavoidable. Furthermore, the market does not provide any solutions that allow a simple cleaning of the three-dimensional objects following their production in order to free them of unsolidified solidifiable materials.

### SUMMARY OF THE INVENTION

In a first aspect of the invention, a cleaning system is provided for cleaning at least one three-dimensional object which is formed by solidification, in particular layer by layer or continuously, of a material which is solidifiable under the action of radiation. The cleaning system comprises a cleaning chamber for receiving the at least one three-dimensional object to be cleaned. The cleaning system comprises at least one cleaning agent container containing uncontaminated cleaning agent. The cleaning chamber and the at least one cleaning agent container are fluidically connected to one another. The cleaning system comprises at least one conveying device for conveying uncontaminated cleaning agent from the at least one cleaning agent container into the cleaning chamber and for conveying contaminated cleaning agent from the cleaning chamber back into the at least one cleaning agent container.

In a second aspect of the invention, a method is provided for cleaning at least one three-dimensional object which is formed by solidification, in particular layer by layer or continuously, of a material which is solidifiable under the action of radiation. In said method at least one cleaning operation is performed. In, said at least one cleaning operation uncontaminated cleaning agent from at least one cleaning agent container is conveyed into a cleaning chamber, in which the at least one three-dimensional object is received, and, following the cleaning of the at least one three-dimensional object, is conveyed back again from the cleaning chamber, in particular fully or substantially fully, into the at least one cleaning agent container.

### BRIEF DESCRIPTION OF THE DRAWING FIGURES

The foregoing summary and the following description may be better understood in conjunction with the drawing figures, of which:

FIG. 1: shows a schematic depiction of a first exemplary embodiment of a cleaning system;

FIG. 2: shows a schematic depiction of a second exemplary embodiment of a cleaning system;

FIG. 3: shows a schematic depiction of a third exemplary embodiment of a cleaning system;

FIG. 4: shows a schematic depiction of a fourth exemplary embodiment of a cleaning system;

FIG. 5: shows a schematic depiction of a fifth exemplary embodiment of a cleaning system;

FIG. 6: shows a schematic depiction of the sequence of a cleaning method;

FIG. 7: shows a schematic depiction of the sequence of a further cleaning method.

### DETAILED DESCRIPTION OF THE INVENTION

Although the invention is illustrated and described herein with reference to specific embodiments, the invention is not intended to be limited to the details shown. Rather, various modifications may be made in the details within the scope and range of equivalents of the claims and without departing from the invention.

The present invention relates to a cleaning system for cleaning at least one three-dimensional object which is formed by solidification, in particular layer by layer or continuously, of a material which is solidifiable under the action of radiation, which cleaning system comprises a cleaning chamber for receiving the at least one three-dimensional object to be cleaned, wherein the cleaning system comprises at least one cleaning agent container containing uncontaminated cleaning agent, wherein the cleaning chamber and the at least one cleaning agent container are fluidically connected to one another, wherein the cleaning system comprises at least one conveying device for conveying uncontaminated cleaning agent from the at least one cleaning agent container into the cleaning chamber and for conveying contaminated cleaning agent from the cleaning chamber back into the at least one cleaning agent container.

The cleaning system proposed in accordance with the invention allows, in a simple way, in particular an automatic cleaning of three-dimensional objects which have been formed for example by the described 3D printing from a liquid solidifiable material. Cleaning agent can be conveyed by means of the at least one conveying device automatically from a cleaning agent container into the cleaning chamber, where the cleaning agent rinses off or removes from the three-dimensional object any unsolidified solidifiable material in order to free the object fully or substantially fully of unsolidified solidifiable material. If the cleaning procedure, also referred to hereinafter as a cleaning operation, is completed, the cleaning agent can be conveyed back again into the cleaning agent container by means of the conveying device. The cleaning agent container by means of which the uncontaminated cleaning agent was provided is thus used to receive the contaminated cleaning agent once a cleaning operation has been performed. The cleaning agent which is thus contaminated, i.e. has been used at least once, can now be disposed of easily, more specifically together with the cleaning agent container. The cleaning system allows in particular a cleaning of three-dimensional objects, without the need for an operating individual to come into direct contact with the cleaning agent. In addition, the cleaning procedure can be fully automated, i.e. in particular the conveying of the cleaning agent from the cleaning agent container into the cleaning chamber and from the cleaning chamber back again into the cleaning agent container. Optionally or alternatively, it is of course also possible to convey the cleaning agent that is contaminated, i.e. used at least once, into a further provided disposal container. This may be advantageous in particular in order to prevent containers which contain uncontaminated and contaminated cleaning agent from being mixed up. The at least one conveying device can be configured in particular in the form of a fluid pump in order to convey liquid cleaning agents from cleaning agent containers into the cleaning chamber and back again. Uncontaminated cleaning agent in this context can be, in particular, cleaning agent which is free from any contamination with unsolidified solidifiable material. Such cleaning agent has therefore never been used for cleaning three-dimensional objects of unsolidified solidifiable material. Contaminated cleaning agent in this context can be, in particular, cleaning agent which is contaminated with unsolidified solidifiable material, that is to say already contains such material. Uncontaminated cleaning agent in the further sense, however, can also be cleaning agent of which the degree of contamination is lower than the degree of contamination of the contaminated cleaning agent. For example, weakly contaminated cleaning agent can thus be used as “uncontaminated” cleaning agent in order to perform a cleaning procedure or a cleaning process in the cleaning chamber. In this case, the degree of contamination in the cleaning agent of unsolidified solidifiable material increases. Following the cleaning procedure, the cleaning agent is “contaminated”, i.e. it has a higher degree of contamination of unsolidified solidifiable material than prior to the cleaning procedure. In order to limit the consumption of cleaning agent, “contaminated” cleaning agent can in particular also be used again as “uncontaminated” cleaning agent. In particular, this is also possible a number of times, more specifically for example until a degree of contamination of unsolidified solidifiable material in the “contaminated” cleaning agent, i.e. after a cleaning process, is so high that it no longer can be or should be used for cleaning.

It is advantageous if the cleaning chamber has a base, if a support element for the at least one three-dimensional object to be cleaned is arranged or formed in the cleaning chamber at a spacing from the base, and if the support element is fluid-permeable. A configuration of this kind of the cleaning chamber with a support element makes it possible in particular for the cleaning agent to reliably flow from all sides around the three-dimensional object to be cleaned. In addition, the arrangement of the support element at a spacing from the base of the cleaning chamber makes it possible to arrange optional components of the cleaning system between the support element and the base, which optional components are not intended to come into contact with the object to be cleaned. In particular, the support element can be configured in the form of a metal mesh or a metal or plastic grid. The support element is preferably formed from a material which is not attacked by the cleaning agents used in the cleaning system. For example, the support element can be formed from a stainless steel.

The cleaning chamber can be fluidically connected to the conveying device in a simple way if the cleaning chamber has a cleaning agent inlet which is fluidically connected to the at least one conveying device.

The cleaning agent inlet is favourably arranged at the base of the cleaning chamber. Such an arrangement of the cleaning agent inlet in particular has the advantage that when emptying the cleaning chamber, i.e. in particular when conveying contaminated cleaning agent back into the cleaning container, it is possible to empty the cleaning chamber fully or substantially fully. In particular, dead volumes can thus be avoided. In addition, the contaminated cleaning agent can flow out through the cleaning agent inlet at the base in a manner assisted by the force of gravity.

In order to further improve an emptying of the cleaning chamber, it is favourable if the base is funnel-shaped and if the cleaning agent inlet is arranged or formed at the lowest point or region of the cleaning chamber in the direction of the force of gravity.

In accordance with a preferred embodiment of the invention, it can also be provided that the cleaning system comprises a movement device for moving the cleaning agent in the cleaning chamber. The movement device can be configured in particular in the form of a recirculation device in order to achieve the removal of unsolidified solidifiable material from the three-dimensional object as fully as possible by movement of the cleaning agent in the cleaning chamber.

It is favourable if the movement device comprises a stirring device and/or a fluid mechanical fluid jet generation device with at least one nozzle for moving the cleaning agent. In particular, the movement device can be configured to generate a turbulent flow in the cleaning chamber filled with cleaning agent. A movement device formed in this way makes it possible in particular to apply a flow of the cleaning agent at a relatively high speed to the three-dimensional object to be cleaned, in order to rinse off and remove, in an optimal manner, the solidifiable material adhering to the object. The stirring device can be formed in particular in the manner of a magnetic stirrer. In particular in order to be able to generate turbulent jets, the stirring device can comprise one or more propeller-like stirring elements. Stirring elements of the stirring device can be driven in particular by a magnetic coupling through a wall of the cleaning chamber, so that no through openings on the cleaning chamber have to be sealed off in connection with the stirring device.

The movement device is favourably arranged or formed between the support element and the base. In this way, the movement device is arranged in a protected manner. In particular, three-dimensional objects to be cleaned are unable to come into contact with the movement device or components thereof.

In order to prevent in particular large amounts of volatile cleaning agent escaping from the cleaning chamber, it is favourable if the cleaning chamber is closed by a removable cover at the top in relation to the direction of the force of gravity. In particular, the cover can be formed in such a way that it is possible to close the cleaning chamber gas-tight or substantially gas-tight. This has advantages in particular if cleaning agents that are odorous and harmful to health are used, which, where possible, should not be inhaled.

It is furthermore favourable if the cleaning system comprises a drying device. The drying device makes it possible in particular to dry both the cleaned three-_g dimensional object and the cleaning chamber following one or more cleaning operations. A drying step also has the advantage in particular that volatile cleaning agents can be removed fully, which leads to a reduction of any unpleasant odours at the place of use of the cleaning system.

The cleaning system can be formed in a particularly compact manner if the drying device is arranged or formed in the cover.

It is favourable if the drying device comprises a recirculation fan for conveying gas from the cleaning chamber to a dehumidification device and from the dehumidification device back into the cleaning chamber. The recirculation fan or circulation fan in particular allows complete emptying of volatilized cleaning agent from the cleaning chamber. The cleaning chamber can then be opened, after the drying, by removing the cover, and an operating individual can then remove the cleaned and dried object from the cleaning chamber, practically without any unpleasant odours. In particular, water and vaporized constituents of the cleaning agent can be removed by means of the dehumidification device, so that the cleaning chamber preferably only still contains ambient air after the drying process.

It is further advantageous if the cleaning system comprises an exhaust air treatment device. In particular, substances that are harmful to health or possibly toxic, which can escape from the cleaning agent can be removed from the treatment chamber by means of the exhaust air treatment device, before the treated exhaust air is discharged from the cleaning chamber into the environment surrounding the cleaning system.

This exhaust air of the cleaning system can be treated easily if the exhaust air treatment device comprises at least one filter. The filter is preferably configured in the form of an activated carbon filter. For example, chemicals such as methanol, which disseminate unpleasant odours, can be absorbed in a defined way by means of such an activated carbon filter and can be disposed of together with the filter.

A particularly compact configuration of the cleaning system can be achieved in particular if the exhaust air treatment device is arranged or formed in the cover.

In particular, the exhaust air treatment device can be integrated into the drying device or can form a part thereof.

In accordance with a further preferred embodiment, it can be provided that the cleaning system comprises at least two cleaning agent containers. This makes it possible, in particular, to use a cleaning agent from a first cleaning agent container for a first cleaning operation and to use a cleaning agent from a second cleaning agent container for a second cleaning operation. The cleaning agent is for example conveyed from the first cleaning agent container into the cleaning chamber, the object therein is cleaned, and then the contaminated cleaning agent is conveyed back into the cleaning agent container. For example, a second cleaning operation can then be performed by conveying the cleaning agent from a second cleaning agent container into the cleaning chamber. The cleaning agent contaminated with the second cleaning operation can then be conveyed back again into the second cleaning agent container. In principle, it is also possible for three, four or more cleaning agent containers to be provided. In particular, the cleaning agent containers can contain different cleaning agents, so that cleaning of the three-dimensional objects can be further optimised.

In order to prevent a contamination and possibly an undesired reaction in the event that different cleaning agents meet, it is favourable if there is associated with each of the at least two cleaning agent containers its own conveying device. In this way, in particular a disposal of the cleaning agent containers with contaminated cleaning agent can also be simplified since there is in essence no need to dispose of any mixed chemicals.

The at least two cleaning agent containers favourably contain different cleaning agents. For example, methanol can be provided in one cleaning agent container and isopropyl alcohol can be provided in a second cleaning agent container for cleaning the three-dimensional objects. Different cleaning agents can in particular also be cleaning agents with a different degree of contamination. For example, a first cleaning agent container can contain methanol without any or with a low degree of contamination of unsolidified solidifiable material. A second cleaning agent container can likewise contain methanol, but with a higher degree of contamination. In particular, a first cleaning process can then be performed with the cleaning agent contaminated to a greater extent with unsolidified solidifiable material, and a second cleaning process can then be performed with the cleaning agent contaminated to a lesser extent with unsolidified solidifiable material. Furthermore, different cleaning agents can also be cleaning agents with a different degree of concentration, i.e. for example an aqueous solution with a methanol content of 50% and an aqueous solution with a methanol content of 70%.

It is advantageous if the cleaning system is configured to perform a first cleaning process with the cleaning agent which is contained in a first of the at least two cleaning agent containers and to perform a second cleaning process with the cleaning agent which is contained in a second of the at least two cleaning agent containers. The cleaning agent from the first cleaning container can be conveyed into the cleaning chamber and can be used for a first cleaning process of the at least one three-dimensional object. This cleaning agent can then be conveyed into the first cleaning container again. The cleaning agent then has a higher degree of contamination than before the first cleaning process. For the second cleaning process, the cleaning agent from the second cleaning agent container can be conveyed into the cleaning chamber and can be used for a second cleaning process. This cleaning agent can then be conveyed into the second cleaning container again. If the cleaning agents in the first and in the second cleaning agent container had an identical degree of contamination of still unsolidified solidifiable material before the first and second cleaning operation, the cleaning agent from the second cleaning agent container, after the first cleaning process, then normally has a lower degree of contamination than the cleaning agent in the first cleaning agent container.

It is favourable if the cleaning system is configured to perform, after the second cleaning process, a third cleaning process with the cleaning agent conveyed back into the first cleaning agent container after the first cleaning process and to perform, after the third cleaning process, a fourth cleaning process with the cleaning agent conveyed back into the second cleaning agent container after the second cleaning process. As a result of this sequence, in the event of the repeated use of the cleaning agents already used, it can be ensured in particular that, in the case of the repeated cleaning of objects already cleaned or in the case of the first cleaning of newly produced objects, a kind of preliminary cleaning with the more heavily contaminated cleaning agent from the first cleaning agent container is firstly performed, and then the fourth cleaning process with the less heavily contaminated cleaning agent is performed. As a result of this multiple use of the cleaning agents, cleaning agent can be saved in particular, because the cleaning agent in the second cleaning agent container is less heavily contaminated after the second cleaning process than the cleaning agent in the first cleaning agent container after the first cleaning process. The described sequence can be performed in particular before a three-dimensional object which has not yet been cleaned is subjected to a first cleaning procedure.

In order to further improve the handling of the cleaning system, it is favourable if the cleaning system comprises a receiving container for the at least one cleaning agent container and if the receiving container comprises at least one intake pipe, fluidically connected to the cleaning chamber, for introduction into the at least one cleaning agent container. For example, the cleaning agent container can be provided in bottle form with screw closures. In order to fill the cleaning chamber, it is then merely necessary for the intake pipe to be introduced into the opened cleaning agent container. The one or more cleaning processes can then be performed in principle fully automatically by the cleaning system with appropriate configuration. The receiving container can be configured in particular in such a way that it defines a substantially closed receiving space for the at least one cleaning agent container. In particular, an undefined volatilisation of cleaning agents at the location where the cleaning system is used can thus be largely prevented. In addition, such a receiving container can ensure a secure positioning of the cleaning agent containers so that they cannot tip over, which might result in the cleaning agent escaping from the cleaning agent container in an undefined manner.

For defined operation of the cleaning system, it is favourable in particular if the at least one cleaning agent container comprises a memory element for storing at least one parameter characterising the cleaning agent contained in the at least one cleaning agent container. The at least one parameter can be, in particular, the type of cleaning agent and/or a volume of the cleaning agent contained in the cleaning agent container and/or a chemical property and/or physical property of the cleaning agent. Further parameters or data are in particular a purity of the cleaning agent and any hazard warnings.

The cleaning system preferably comprises a readout unit for reading the parameters and/or data stored in the memory element from the memory element. The readout device can be, in particular, a contactless readout device, which allows the memory element to be read without direct contact. For example, the readout device can be configured in the form of an optical or near-field readout device. In particular barcodes can thus be scanned or RFID chips can thus be read.

It is advantageous if the readout device is arranged or formed on the receiving container. This makes it possible in particular to insert cleaning agent containers into the receiving container and to automatically read the data or parameters stored in the memory element.

The cleaning system can be formed in a simple way if the memory element comprises a barcode or an RFID chip.

In accordance with a further preferred embodiment, it can be provided that the cleaning system comprises a control device for controlling the cleaning system. In particular, components of the cleaning system can be easily and reliably actuated by means of the control device. In particular, automatic operation of the cleaning system can thus be made possible.

It is advantageous if the control device comprises a time setting device for setting a cleaning time during which the cleaning agent remains in the cleaning chamber after having been conveyed from the at least one cleaning agent container and before being conveyed back into the at least one cleaning agent container. Such a time setting device has in particular the advantage that the object to be cleaned does not remain in contact with the cleaning agent for too long, which in the worst case scenario, depending on the cleaning agent, could lead to a partial disintegration of the object. The intent and purpose of the cleaning system is merely to remove unsolidified solidifiable material from the three-dimensional object, but not to alter the three-dimensional object or damage it as a result of the cleaning. In cooperation with the control device, the amount of time for which the cleaning agent remains in the cleaning chamber can be automatically limited by the time setting device. In particular if the type of cleaning agent is known, this information can be transferred to the control device by an operating individual or automatically by means of the above-described readout device in conjunction with a memory element arranged on the cleaning agent container. Errors during the cleaning of the three-dimensional objects can thus be ruled out or at least minimised.

It is advantageous if the control device is configured to automatically set the cleaning time depending on the solidifiable material from which the at least one three-dimensional object to be cleaned is formed, and/or depending on the cleaning agent. As described, undesirable interactions between the cleaning agent and the object to be cleaned can be avoided in this way.

It is favourable if the cleaning system comprises an input device for inputting the type of solidifiable material from which the at least one three-dimensional object to be cleaned is formed. In particular, the input device can also be configured for inputting the cleaning agent that is to be used to clean the three-dimensional object. The cleaning system can then choose and set a cleaning time under consideration of the input data, in particular automatically as described.

It is favourable if the cleaning system comprises a display device for displaying operating parameters and/or operating modes of the cleaning system. Information regarding the cleaning process can thus be displayed on the display device in a simple way to an operating individual. In particular, warnings or operating errors of the cleaning system can be displayed on the display device, for example if the incorrect or an uncertified cleaning agent were to be used.

It is advantageous if the cleaning system is configured to display to the user a degree of utilisation of the cleaning agent, in particular by means of the display device. A user can thus immediately identify whether he can continue to use the cleaning agent or whether he must replace the cleaning agent, as the case may be, for new cleaning agent or for cleaning agent contaminated to a lesser extent.

In accordance with a preferred embodiment, it can be provided that the control device is coupled for control purposes to the at least one conveying device and/or to the at least one movement device and/or to the drying device and/or to the exhaust air treatment device and/or to the readout device and/or to the input device and/or to the display device. In particular if the control device is coupled for control purposes to all of the stated devices, a cleaning of three-dimensional objects can be performed in fully automated fashion or in substantially fully automated fashion.

It is favourable if the control device is configured to deactivate the at least one conveying device depending on a predefined maximum degree of utilisation or contamination of the cleaning agent. It can thus be ensured that a user cannot continue to use the cleaning system if a degree of contamination or degree of utilisation exceeds a predefined limit value.

In order to avoid the escape of odorous gases, in particular of the volatilised cleaning agents, it is advantageous if the cleaning system is fluid-tight. In particular, the cleaning system can be gas-tight.

The invention further relates to a method for cleaning at least one three-dimensional object which is formed by solidification, in particular layer by layer or continuously, of a material which is solidifiable under the action of radiation, in which method at least one cleaning operation is performed, in which at least one cleaning operation uncontaminated cleaning agent from at least one cleaning agent container is conveyed into a cleaning chamber, in which the at least one three-dimensional object is received, and, following the cleaning of the at least one three-dimensional object, is conveyed back again from the cleaning chamber, in particular fully or substantially fully, into the at least one cleaning agent container.

Cleaning three-dimensional objects in the described way has the advantage in particular that cleaning agent containers by means of which uncontaminated cleaning agents for cleaning the three-dimensional objects are provided can receive contaminated cleaning agents again, thus allowing a simple disposal of the contaminated cleaning agents. The execution of a cleaning method can thus be simplified on the whole and said method can be performed with correct disposal of cleaning agents.

In order to allow particularly good cleaning of the three-dimensional objects, it is advantageous if two or more cleaning operations are performed.

In order to be able to remove unsolidified solidifiable material particularly efficiently from three-dimensional objects, it is favourable if a different cleaning agent is used in each of the two or more cleaning processes. In particular, different cleaning agents which are able to remove different constituents of the solidifiable material can be used.

In order to prevent in particular a mixing of different cleaning agents, it is advantageous if the cleaning chamber is emptied fully after each cleaning operation.

In order to ensure an optimal cleaning of the three-dimensional object, it is favourable if the cleaning agent conveyed into the cleaning chamber remains in the cleaning chamber for a cleaning time. In particular, this may be a minimum residence time. Furthermore, the cleaning time can also be limited in a predefined manner, in order to avoid damage to the three-dimensional object to be cleaned.

It is advantageous if the cleaning time is predefined depending on the solidifiable material from which the at least one three-dimensional object to be cleaned is formed, and/or depending on the cleaning agent. In this way, in particular on the one hand an optimal cleaning can be ensured and on the other hand damage to the three-dimensional object to be cleaned can be avoided. In particular, a cleaning time can thus be limited in a simple way. A residence time of the cleaning agent in the cleaning chamber is ideally selected so that as much still unsolidified solidifiable material as possible can be removed from the three-dimensional object without damaging the object.

So as to be able to ensure an optimal removal of unsolidified solidifiable material from the three-dimensional object to be cleaned, it is advantageous if the cleaning agent conveyed into the cleaning chamber is moved in the cleaning chamber in order to clean the at least one three-dimensional object. In particular, the cleaning agent can be moved in such a way that a turbulent flow thereof is created in the cleaning chamber, whereby any still unsolidified solidifiable material can be rinsed away optimally from the three-dimensional object.

It is also advantageous if, following the at least one cleaning operation, the cleaning chamber emptied of the cleaning agent is dried. The three-dimensional object received in the cleaning chamber is automatically also dried at the same time. In particular, it is advantageous if such a drying is performed after the last cleaning operation. The cleaning chamber can then be opened, and the clean three-dimensional object removed, without any excessive unpleasant odours being produced in the surroundings of one of the above-described cleaning systems.

In order to avoid unpleasant odours in the surroundings in particular of a cleaning system for performing one of the described methods, it is favourable if any odours that escape during the drying of the cleaning chamber are filtered out. This can be achieved for example using one or more activated carbon filters.

Furthermore, the use of one of the above-described cleaning systems to carry out one of the above-described methods is proposed.

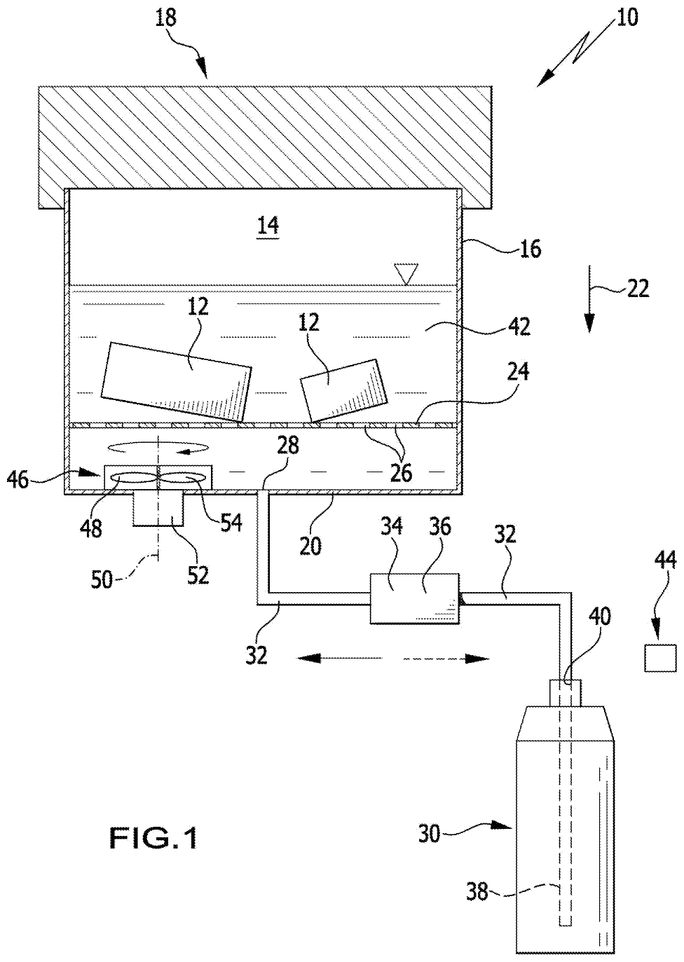

A first exemplary embodiment of a cleaning system 10 for cleaning one or more three-dimensional objects 12, which are formed by solidification, in particular layer by layer or continuously, of a material which is solidifiable under the action of radiation, is shown schematically in FIG. 1.

The cleaning system 10 comprises a cleaning chamber 14, which is defined by a tank-like container 16. The container 16 is open upwardly in relation to the direction of the force of gravity and is selectively closed by a removable cover 18. The direction of the force of gravity is symbolised schematically in FIG. 1 by the arrow 22.

A support element 24 extending substantially parallel to the base 20 and transversely to the direction of the force of gravity is arranged at a spacing from the base 20. The support element is fluid-permeable and has a plurality of apertures 26.

The support element 24 is formed selectively from a grid or mesh made of a metal or plastic.

A cleaning agent inlet 28 is arranged or formed on the cleaning chamber 14. In the exemplary embodiment shown in FIG. 1, the cleaning agent inlet 28 is arranged or formed on the base 20.

The cleaning chamber 14 is fluidically connectable to a cleaning agent container 30. For this purpose, a connection line 32 is provided, which fluidically connects the cleaning agent inlet 28 to a conveying device 34 in the form of a liquid pump 36, and also the liquid pump 36 to the cleaning agent container 30. A free end of the connection line 32 is configured in the form of an intake pipe 38, which passes into the cleaning agent container 30 through an opening 40 of said container.

To clean three-dimensional objects 12, these are introduced into the cleaning chamber 14 so that they lie on the support element 24. The intake pipe 38 of the connection line 32 is introduced into the cleaning agent container 30 filled with uncontaminated cleaning agent.

The content of the cleaning agent container 30 is conveyed into the cleaning chamber 14 by means of the conveying device 34. As shown schematically in FIG. 1, the objects 12 are surrounded fully by the cleaning agent 42.

Following a cleaning time, also referred to as residence time of the cleaning agent 42 in the cleaning chamber 14, the cleaning agent 42 now contaminated with still unsolidified solidifiable material, which adheres to the objects 12 after their production, is conveyed by means of the conveying device 34 out of the cleaning chamber 14 and back into the cleaning agent container 30.

The cleaning chamber 14 is now empty and can be opened by lifting off the cover 18, for example to dry out or dry off the objects 12.

The intake pipe 38 is then removed from the cleaning agent container 30 filled with contaminated cleaning agent, and the cleaning agent container 30 is closed by a closure 44. The contaminated cleaning agent 42 can thus be disposed of in a simple and safe way in the cleaning agent container 30.

The cleaning system 10 optionally comprises a movement device 46 for moving the cleaning agent 42 in the cleaning chamber 14. The movement device 46 is formed selectively as a stirring device or in the form of a fluid mechanical fluid jet generation device having at least one nozzle. In particular, the movement device 46 is configured to generate a turbulent flow in the cleaning chamber 14 filled with cleaning agent 42.

The movement device 46 is equipped in one exemplary embodiment with a propeller 48, which is arranged rotatably about a rotation axis 50 and is set in rotation in order to move the cleaning agent 42. To this end, a drive device 52 is provided, which is magnetically coupled to a propeller 48 forming a movement element 54, so that it is possible to dispense with an aperture in the cleaning chamber 14.

The movement device 46 is arranged between the base 20 and the support element 24. In this way, it can be ensured that the objects 12 cannot come into contact with the movement device 46.

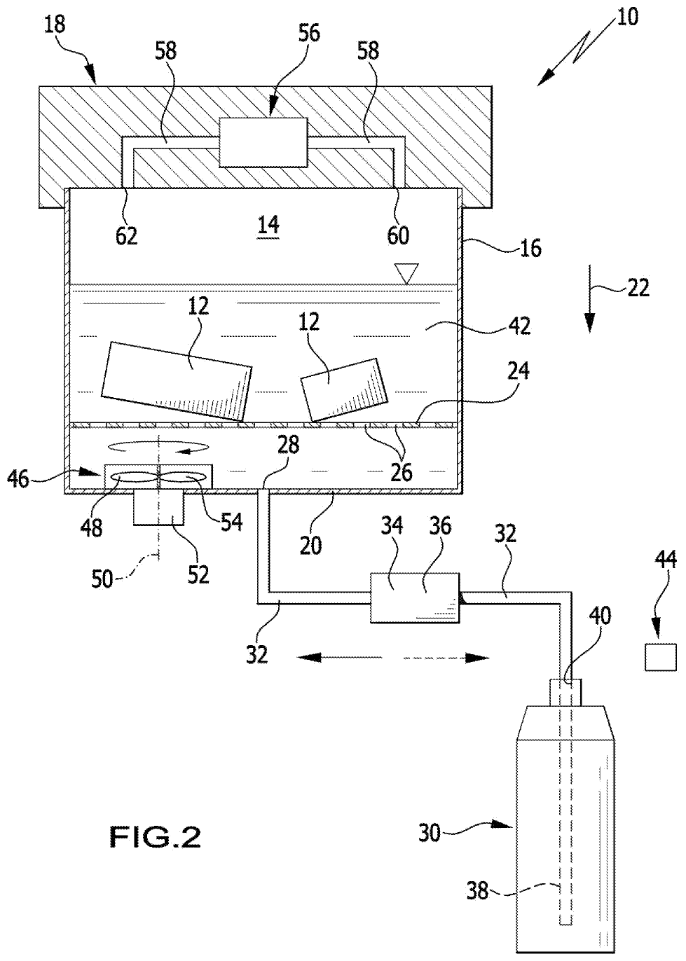

A second exemplary embodiment of a cleaning system 10 is shown schematically in FIG. 2. In terms of its configuration, it corresponds substantially to the first exemplary embodiment of the cleaning system 10. Components and elements that are identical or that are comparable in respect of their function are therefore provided with the same reference numerals as in the first exemplary embodiment of the cleaning system 10.

The second exemplary embodiment of the cleaning system 10 comprises a drying device 56, which is arranged or formed in the cover 18. The drying device is fluidically connected by means of a connection line 58 to an inlet 60 and an outlet 62 on the cover. Gases contained in the cleaning chamber 14 can flow in through the inlet 60 and in the drying device 56 can be removed from a gas flow. The dried gas flow can then be guided from the drying device 56 through the outlet 62 back into the cleaning chamber 14.

The drying device 56 is then preferably operated if, as described above, the contaminated cleaning agent 42 has been conveyed back again into the cleaning agent container 30. The cleaning chamber 14 is then empty and can be dried out fully or substantially fully by means of the drying device 56, with the objects 12 also being dried at the same time. After this drying process, the cover 18 can be taken off from the cleaning chamber 14 in order to remove the objects 12.

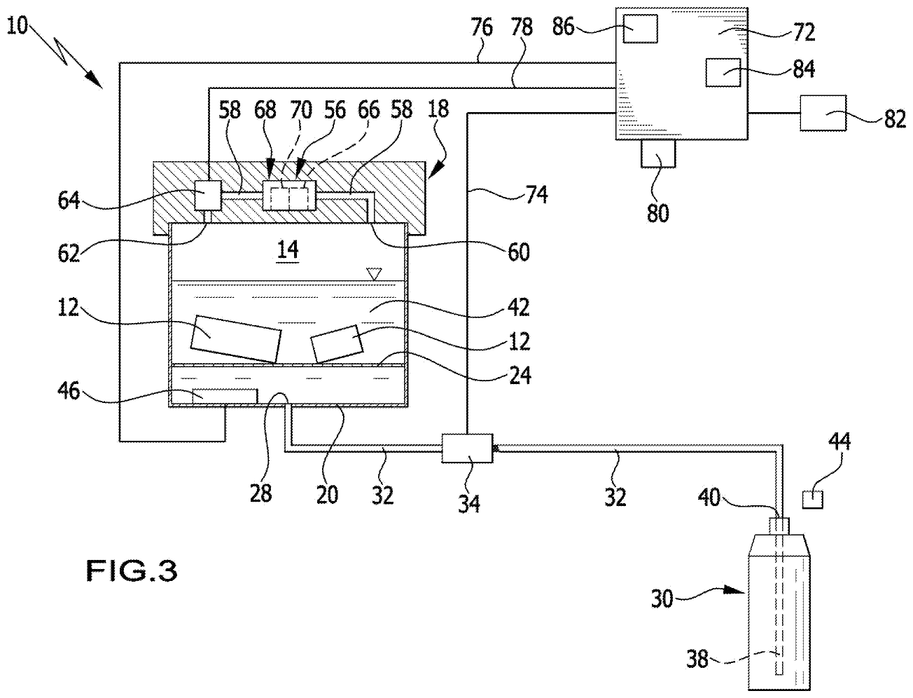

A third exemplary embodiment of a cleaning system 10 is shown schematically in FIG. 3. Again, identical components and elements are denoted in the exemplary embodiment shown in FIG. 3 by the same reference numerals as in the exemplary embodiments shown in FIGS. 1 and 2.

In the third exemplary embodiment, the drying device 56 comprises a recirculation fan 64, which is arranged in the cover 18, in order to dry the gas contained in the cleaning chamber 14, which has been emptied of the cleaning agent 42, through the inlet 60 and the outlet 62 with a sufficiently great volume flow rate in order to achieve a quick and efficient drying.

The drying device 56 further comprises a dehumidification device 66 for removing vaporized cleaning agent 42 from the exhaust air flow conveyed through the connection line 58.

The cleaning system 10 further comprises an exhaust air treatment device 68 with a filter 70. This filter is configured in the form of an activated carbon filter in one exemplary embodiment.

The exhaust air treatment device 68 is arranged or formed in the cover 18 in the third exemplary embodiment of the cleaning system 10.

The drying device 56 in one exemplary embodiment comprises the filter 70. In further exemplary embodiments, two or more filters 70 can also be provided.

The cleaning system 10 further comprises a control device 72 for controlling the cleaning system 10. The control device 72 is connected for control purposes by means of control lines 74, 76 and 78 to the conveying device 34, the movement device 46 and/or to the recirculation fan 64, in order to control these in desired manner and optionally also by closed-loop control.

The cleaning system 10 further comprises a time setting device 80 for setting a cleaning time. The cleaning time is the time during which the cleaning agent 42, after having been conveyed from the cleaning container 30, remains in the cleaning chamber 14 before it is conveyed back into the cleaning container 30 by means of the conveying device 34. The time setting device 80 is connected for control purposes to the control device 72 or is comprised by the latter.

The cleaning system 10 optionally comprises an input device 82 for inputting the type of solidifiable material from which the at least one three-dimensional object 12 to be cleaned is formed, and/or the type of cleaning agent 42 that is to be used to clean the objects 12.

In one exemplary embodiment the control device 72 is configured to automatically set the cleaning time depending on the solidifiable material from which the at least one three-dimensional object 12 to be cleaned is formed, and/or depending on the cleaning agent 42. The data necessary for this purpose can either be input by means of the input device 82 or can be stored for different types of solidifiable materials and different types of cleaning agents 42 in a memory 84 of the control device 72.

To use the cleaning system 10, for example a user can input desired parameters by means of the input device 82, which parameters can be displayed to the user by means of a display device of the cleaning system 10.

The input device 82 and the display device 86 can be combined in the form of a touch display in one exemplary embodiment.

The display device 86 is configured in particular to display operating parameters and/or operating modes of the cleaning system 10.

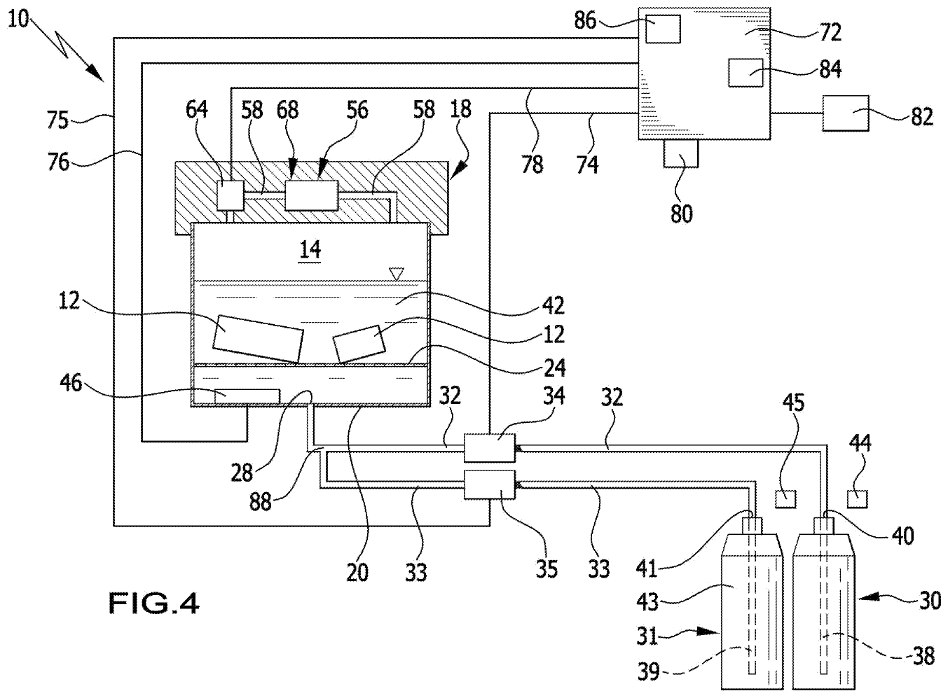

A fourth exemplary embodiment of a cleaning system 10 is shown schematically in FIG. 4. It comprises all the components of the third exemplary embodiment of the cleaning system 10 shown schematically in FIG. 3. It differs from this, however, in that a second cleaning agent container 31, which is filled with a second uncontaminated cleaning agent 43, is fluidically connected by means of a connection line 33 to a second conveying device 35, which is in turn fluidically connected by means of the connection line 33 to the cleaning agent inlet 28 of the cleaning chamber 14.

The connection lines 32 and 33 are fluidically connected to one another by means of a T-piece 88 in the region of the cleaning agent inlet 28.

The control device 72 is connected for control purposes to the conveying device 35 by means of a control line 75.

A free end of the connection line 33 forms an intake pipe 39 similarly to the intake pipe 38.

The cleaning agent container 31 has an opening 41, through which the intake pipe 39 can be introduced into the cleaning agent container 31. A closure 45 is used to close the opening 41.

With the fourth exemplary embodiment of the cleaning system 10, the objects 12 can be cleaned in at least two cleaning operations by means of the cleaning agents 42 and 43. For example, the initially empty cleaning chamber 14 can be filled with the cleaning agent 42 by means of the conveying device 34. The cleaning agent 42 is moved by means of the movement device 46 in the described manner. The cleaning time is predefined by the control device 72 under consideration of the parameters predefined for the cleaning agent 42 and the solidifiable material from which the objects 12 are produced.

At the latest at the end of the cleaning time, the conveying device 34 conveys the contaminated cleaning agent 42 from the cleaning chamber 14 back into the cleaning agent container 30.

Uncontaminated cleaning agent 43 can then be pumped from the cleaning agent container 31 by means of the conveying device 35 into the cleaning chamber 14. In this second cleaning operation, which is assigned a cleaning time suitably adapted to the cleaning agent 43, the cleaning agent 43 is moved in the cleaning chamber by means of the movement device 46, and once the cleaning time has expired is pumped from the cleaning chamber 14 back into the cleaning agent container 31 by means of the conveying device 35.

Once the cleaning chamber 14 has been emptied, it can be dried, as described above, by means of the drying device 56. An exhaust air treatment can be performed with the exhaust air treatment device 68.

If the degree of contamination of the cleaning agents 42 and 43 with unsolidified solidifiable material before the two cleaning operations is initially the same, the degree of contamination of the second cleaning agent 43 in the second cleaning agent container 31 is normally lower than the degree of contamination of the first cleaning agent 42 in the first cleaning agent container 30. This can be utilised in the fourth exemplary embodiment of the cleaning system 10 in particular for the cleaning of further objects 12 that have not yet been cleaned, more specifically in that a first cleaning process of these objects is performed firstly with the cleaning agent 42, already used once, from the first cleaning agent container 30, and then subsequently a second cleaning process is performed with the cleaning agent 43, already used once, from the second cleaning agent container 31. Resources, in particular used cleaning agent, can thus be used sparingly by using the cleaning agents multiple times.

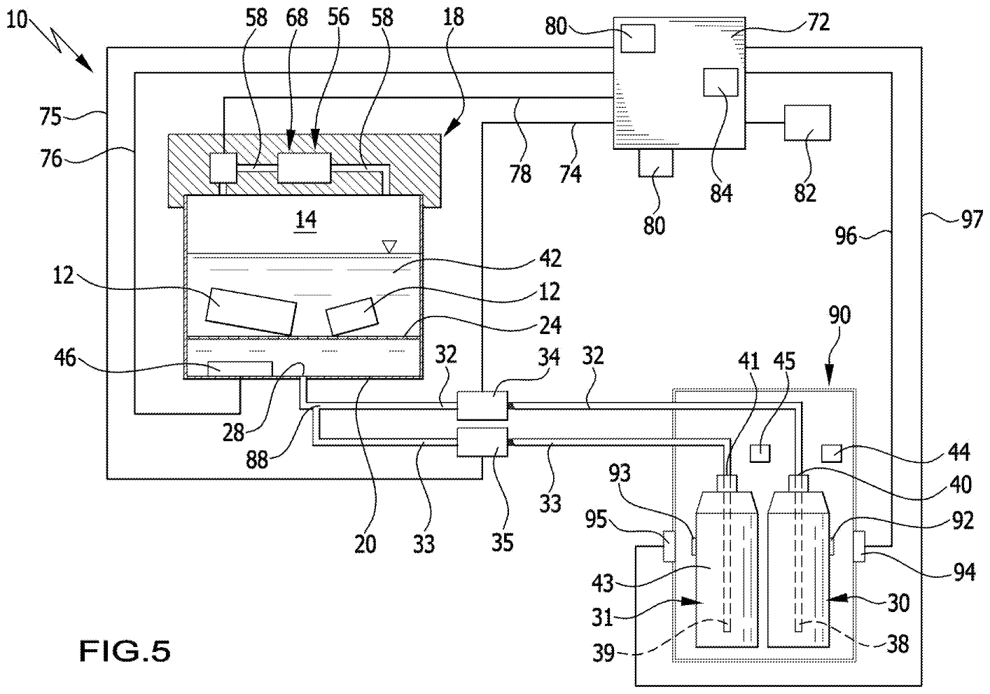

A fifth exemplary embodiment of a cleaning system 10 is shown schematically in FIG. 5. It comprises all components of the fourth exemplary embodiment of the cleaning system 10 which is shown by way of example in FIG. 4. In addition, the fifth exemplary embodiment comprises a receiving container 90 for receiving the cleaning agent containers 30 and 31. These are accommodated in protected fashion in the receiving container 90 and in particular are secured against tipping over.

Furthermore, this exemplary embodiment of the cleaning system 10 comprises agent containers 30 and 31, which each carry a memory element 92 and 93 respectively for storing at least one parameter characterising the cleaning agents 42 and 43 contained in the cleaning containers 30 and 31. Parameters in this case are, for example, the type of cleaning agent 42 or 43 and also the volume of the cleaning agent 42 or 43 contained in the cleaning agent containers 30 and 31.

The cleaning system 10 further comprises a readout device 94. Two readout devices 94 and 95 can also be provided optionally. The readout devices 94 and 95 are configured to read the parameters or data stored in the memory elements 92 and 93.

The readout devices 94 and 95 are arranged or formed on the receiving container 90 in the exemplary embodiment of the cleaning system 10. This allows an automatic readout of the memory elements 92 and 93 when the cleaning agent containers 30 and 31 are received in the receiving containers 90.

Two readout devices 94 and 95 are provided in particular in exemplary embodiments in which the memory elements 92 and 93 are configured in the form of barcodes. A reliable detection of the barcodes of both cleaning agent containers 30 and 31 can thus be ensured.

A single readout device 94 is sufficient for example if the memory elements 92 and 93 are configured in the form of RFID chips.

The readout devices 94 and 95 are connected by means of data lines 96 and 97 to the control device 72 in order to transmit the read data from the readout device 94 and/or the readout device 95 to the control device 72.

Providing cleaning agent containers 30 and 31 equipped with the memory elements 92, 93 makes it possible to transmit the type of the cleaning agent 42 or 43 automatically to the control device 72. A manual input by an operator by means of the input device 82 is no longer absolutely necessary in this case.

The receiving container 90 can be formed in particular in closed fashion and can surround the cleaning agent containers 30 and 31, in particular gas-tightly, when these are received in it, in order to keep any unpleasant odours in the environment of the cleaning system 10 to a minimum.

The above-described exemplary embodiments of cleaning systems 10 can comprise in particular cleaning chambers 14 with a base 20, which is funnel-shaped, wherein the cleaning agent inlet 28 is arranged and formed in the region of the cleaning chamber 14 at the lowest point in the direction of the force of gravity.

In particular, different types of cleaning methods can be performed with the above-described exemplary embodiments of cleaning systems 10, that is to say methods for cleaning three-dimensional objects 12 which are formed by solidification, in particular layer by layer or continuously, of a material which is solidifiable under the action of radiation.

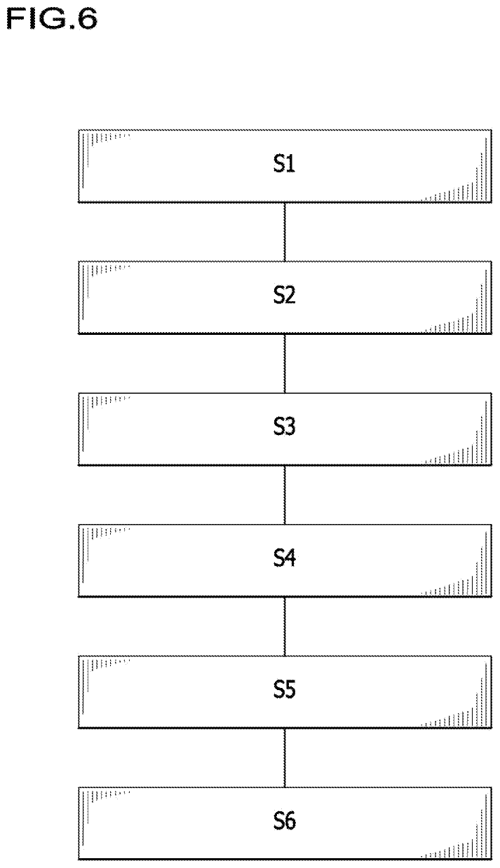

FIG. 6 shows schematically the sequence of a cleaning method.

In step S1, the objects 12 are introduced into the cleaning chamber 14. In the next step S2, uncontaminated cleaning agent 42 is conveyed from the cleaning agent container 30 into the cleaning chamber 14. In step 3, the cleaning agent 42 is moved in the cleaning chamber 14.

Following a predefined or predefinable cleaning time, in step S4 the cleaning agent 42 is conveyed from the cleaning chamber 14 back into the cleaning agent container 30. In step S5, the cleaning chamber 14 is dried, and thus so too are the objects 12 received therein.

One cleaning operation and thus a simple cleaning method is thus completed. In step S6, the cleaned and dried objects 12 can then be removed from the cleaning chamber 14.

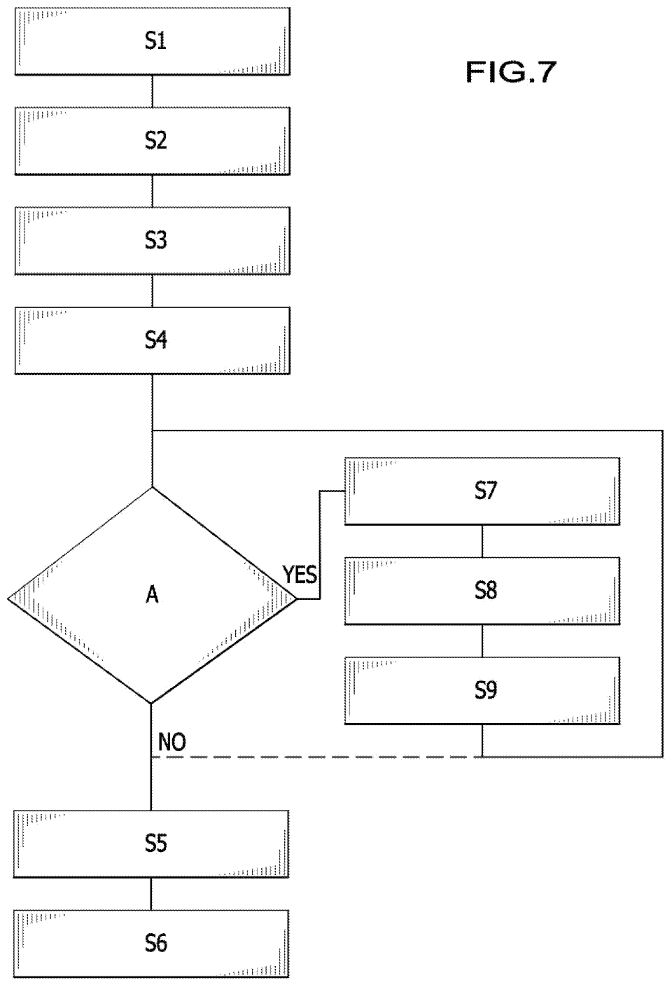

A further variant of a cleaning method and its sequence are shown schematically in FIG. 7. It can be used in particular in conjunction with cleaning systems 10 in accordance with the fourth and fifth exemplary embodiments of cleaning systems 10 described in conjunction with FIGS. 4 and 5.

In the sequence shown in FIG. 7, the steps S1 to S6 correspond to the steps S1 to S6 of the sequence shown in FIG. 6.

A query A takes place between steps S4 and S5 in the cleaning method according to FIG. 7.

If a further cleaning operation is to be performed, the result of the query A is thus “YES” and steps S7 to S9 follow instead of the steps S5 to S6. S7 corresponds here to the step S2, step S8 to step S3, and step S9 to step S4. However, in step S7, the cleaning agent 43 is conveyed from the second cleaning agent container 31 into the cleaning chamber 14. In step S9, the cleaning agent 43 is conveyed back again into the cleaning agent container 31 at the end of the provided cleaning time.

In step S8, the cleaning agent 43 conveyed into the cleaning chamber 14 is moved as described above in order to improve the cleaning result.

Once step S9 is complete, a query A is again performed. Alternatively, if only two cleaning operations are to be performed, it is possible after step S9 to continue the sequence of the cleaning method directly with steps S5 and S6. This is shown schematically in FIG. 7 by the dashed line.

In principle, any number of cleaning agent containers which are filled with different cleaning agents can be provided. In particular, isopropyl alcohol and methanol can be used.

All of the above-described cleaning systems 10 can also optionally be fluid-tight, in particular gas-tight, in order to avoid an escape of gaseous solvents from the cleaning chamber 14 fully or at least largely.

The described cleaning systems 10 and the described cleaning methods allow a simple, safe and in particular environmentally friendly cleaning of three-dimensional objects 12 which have been formed by solidification of a material which is solidifiable under the action of radiation.

### LIST OF REFERENCE NUMERALS

10 cleaning system
12 object
14 cleaning chamber
16 container
18 cover
20 base
22 arrow
24 support element
26 aperture
28 cleaning agent inlet
30 cleaning agent container
31 cleaning agent container
32 connection line
34 conveying device
35 conveying device
36 liquid pump
38 intake pipe
39 intake pipe
40 opening
41 opening
42 cleaning agent
43 cleaning agent
44 closure
45 closure
46 movement device
48 propeller
50 rotation axis
52 drive device
54 movement element
56 drying device
58 connection line
60 inlet
62 outlet
64 recirculation fan
66 dehumidification device
68 exhaust air treatment device
70 filter
72 control device
74 control line
75 control line
76 control line
78 control line
80 time setting device
82 input device
84 memory
86 display device
88 T-piece
90 receiving container
92 memory element
93 memory element
94 readout device
95 readout device
96 data line
97 data line

What is claimed is:

1. A cleaning system for cleaning at least one three-dimensional object which is formed by solidification, in particular layer by layer or continuously, of a material which is solidifiable under the action of radiation, which cleaning system comprises a cleaning chamber for receiving the at least one three-dimensional object to be cleaned, wherein the cleaning system comprises at least one cleaning agent container containing uncontaminated cleaning agent, wherein the cleaning chamber and the at least one cleaning agent container are fluidically connected to one another, wherein the cleaning system comprises at least one conveying device for conveying uncontaminated cleaning agent from the at least one cleaning agent container into the cleaning chamber and for conveying contaminated cleaning agent from the cleaning chamber back into the at least one cleaning agent container.

2. The cleaning system in accordance with claim 1, wherein the cleaning chamber at least one of
a) has a base, wherein a support element for the at least one three-dimensional object to be cleaned is arranged in the cleaning chamber at a spacing from the base, and wherein the support element is fluid-permeable,
wherein, in particular, the base is funnel-shaped, and wherein the cleaning agent inlet is arranged or formed at the lowest point or region of the cleaning chamber in the direction of the force of gravity,
and
b) has a cleaning agent inlet, which is fluidically connected to the at least one conveying device,
wherein, in particular, the cleaning agent inlet is arranged on the base of the cleaning chamber.

3. The cleaning system in accordance with claim 1, wherein the cleaning system comprises a movement device for moving the cleaning agent in the cleaning chamber,
wherein, in particular, the movement device comprises at least one of a stirring device and a fluid mechanical fluid jet generation device with at least one nozzle for moving the cleaning agent, in particular for generating a turbulent flow in the cleaning chamber filled with cleaning agent.

4. The cleaning system in accordance with claim 3, wherein at least one of
a) the movement device is arranged or formed between the support element and the base
and
b) the cleaning chamber is closed by a removable cover at the top in relation to the direction of the force of gravity.

5. The cleaning system in accordance with claim 1, wherein the cleaning system comprises a drying device,
wherein, in particular, the drying device at least one of
a) is arranged or formed in the cover
and
b) comprises a recirculation fan for conveying gas from the cleaning chamber to a dehumidification device and from the dehumidification device back into the cleaning chamber.

6. The cleaning system in accordance with claim 1, wherein the cleaning system comprises an exhaust air treatment device,
wherein, in particular, at least one of
a) the exhaust air treatment device comprises at least one filter, in particular an activated carbon filter,
wherein, in particular, the drying device comprises the at least one filter,
and
b) the exhaust air treatment device is arranged or formed in the cover.

7. The cleaning system in accordance with claim 1, wherein the cleaning system comprises at least two cleaning agent containers,
wherein, in particular, at least one of
a) each of the at least two cleaning agent containers has associated therewith its own conveying device
and
b) the at least two cleaning agent containers contain different cleaning agents
and
c) the cleaning system is configured to perform a first cleaning process with the cleaning agent which is contained in a first of the at least two cleaning agent containers and to perform a second cleaning process with the cleaning agent which is contained in a second of the at least two cleaning agent containers,
wherein, in particular, the cleaning system is configured to perform, after the second cleaning process, a third cleaning process with the cleaning agent conveyed back into the first cleaning agent container after the first cleaning process and to perform, after the third cleaning process, a fourth cleaning process with the cleaning agent conveyed back into the second cleaning agent container after the second cleaning process.

8. The cleaning system in accordance with claim 1, wherein the cleaning system comprises a receiving container for the at least one cleaning agent container, and wherein the receiving container comprises at least one intake pipe, which is fluidically connected to the cleaning chamber, for introduction into the at least one cleaning agent container.

9. The cleaning system in accordance with claim 1, wherein the at least one cleaning agent container comprises a memory element for storing at least one parameter characterising the cleaning agent contained in the at least one cleaning agent container, in particular at least one of the type and volume of the cleaning agent and a chemical property and physical property of the cleaning agent,
wherein, in particular, at least one of
a) the cleaning system comprises a readout device for reading the parameters stored in the memory element from the memory element,
wherein, in particular, the readout device is arranged or formed on the receiving container,
and
b) the memory element comprises a barcode or an RFID chip.

10. The cleaning system in accordance with claim 1, wherein the cleaning system comprises a control device for controlling the cleaning system, wherein, in particular, the control device at least one of
a) comprises a time setting device for setting a cleaning time during which the cleaning agent remains in the cleaning chamber after having been conveyed from the at least one cleaning agent container and before being conveyed back into the at least one cleaning agent container
and
b) is configured to automatically set the cleaning time at least one of depending on the solidifiable material from which the at least one three-dimensional object to be cleaned is formed, and depending on the cleaning agent.

11. The cleaning system in accordance with claim 1, wherein the cleaning system at least one of
a) comprises an input device for inputting the type of solidifiable material from which the at least one three-dimensional object to be cleaned is formed
and
b) comprises a display device for displaying at least one of operating parameters and operating modes of the cleaning system,
wherein, in particular, the cleaning system is configured to display a degree of utilisation of the cleaning agent to a user by means of the display device.

12. The cleaning system in accordance with claim 10, wherein the control device at least one of
a) is coupled for control purposes to at least one of the at least one conveying device and to the at least one movement device and to the drying device and to the exhaust air treatment device and to the readout device and to the input device and to the display device
and
b) is configured to deactivate the at least one conveying device depending on a predefined maximum degree of utilisation or contamination of the cleaning agent.

13. The cleaning system in accordance with claim 1, wherein the cleaning system is fluid-tight, in particular gas-tight.

14. A method for cleaning at least one three-dimensional object which is formed by solidification, in particular layer by layer or continuously, of a material which is solidifiable under the action of radiation, in which method at least one cleaning operation is performed, in which at least one cleaning operation uncontaminated cleaning agent from at least one cleaning agent container is conveyed into a cleaning chamber, in which the at least one three-dimensional object is received, and, following the cleaning of the at least one three-dimensional object, is conveyed back again from the cleaning chamber, in particular fully or substantially fully, into the at least one cleaning agent container.

15. The method in accordance with claim 14, wherein two or more cleaning operations are performed,
wherein, in particular, a different cleaning agent is used in each of the two or more cleaning operations.

16. The method in accordance with claim 14, wherein the cleaning chamber is fully emptied after each cleaning operation.

17. The method in accordance with claim 14, wherein the cleaning agent conveyed into the cleaning chamber remains in the cleaning chamber for a cleaning time,
wherein, in particular, the cleaning time is predefined at least one of depending on the solidifiable material from which the at least one three-dimensional object to be cleaned is formed, and depending on the cleaning agent.

18. The method in accordance with claim 14, wherein the cleaning agent conveyed into the cleaning chamber is moved in the cleaning chamber to clean the at least one three-dimensional object.

19. The method in accordance with claim 14, wherein after the at least one cleaning operation, in particular after the last cleaning operation, the cleaning chamber emptied of the cleaning agent is dried,
wherein, in particular, odours escaping during the drying of the cleaning chamber are filtered out.

20. Use of a cleaning system in accordance with claim 1 to perform a method in accordance with claim 14.
